(19) United States
(12) Patent Application Publication
(10) Pub. No.: US 2006/0007278 A1
(43) Pub. Date: Jan. 12, 2006

(54) Ink delivery system for the continuous refill of ink jet cartridges

(75) Inventors: Carl W. Holland, Webster, NY (US); William A. Putman, Franklin, TN (US)

Correspondence Address: JAMES W. McKEE;Fay, Sharpe, Fagan, Minnich & McKee, LLP, 7th Floor, 1100 Superior Avenue, Cleveland, OH, 44114-2579, US

(73) Assignee: Nu-kote International, Inc., a corporation of Delaware

(21) Appl. No.: 10/886,732

(22) Filed: Jul. 9, 2004

(51) Int. Cl. B41J 2/175

(52) U.S. Cl. 347/85

(57) ABSTRACT

An ink delivery system for an ink cartridge comprises an ink reservoir bag of flexible, plastic sheet material, an ink cartridge and flexible tubing connecting the bag and cartridge in flow communication with one another. The bag is constructed of two sheets of plastic material having peripheral edges bonded together to provide an ink chamber therebetween and has separate fill and exit ports opening into the chamber and respectively defined by a fill tube and an exit tube bonded to the bag between the peripheral edges thereof. The flexible tubing is connected to the exit port through a check valve interposed between the port and tubing, and a lure lock is interconnected with the fill tube to provide an injection sight for filling the bag. The bag is enclosed in a container having openings through which the fill and exit ports extend. An ell fitting provides connection for the tubing to the top wall of the cartridge and clamping and strain relief arrangements are provided for respectively opening and closing the tubing to the flow of ink therethrough and removing the strain from the tubing at the connection to the cartridge.

### BACKGROUND OF THE INVENTION

This invention relates to the art of ink jet printers and, more particularly, to an ink delivery system for the continuous refill of disposable ink jet cartridges.

Disposable ink jet cartridges are of course well known and are designed to operate for a useful life during which the head elements will function appropriately a very high percentage of the time during the life of the cartridge. To insure high performance, such cartridges have a predetermined amount of ink contained within the cartridge, and the amount of ink in the cartridge is a function of the quantity of printing that the printhead elements can do before failing to function at the high performance level. Once the ink in the cartridge is used, the cartridge is discarded. Most often, when such a cartridge runs out of ink the printhead is still adequately functional, whereby discarding the cartridge is wasteful. Moreover, the necessity to frequently replace inkjet cartridges is both time and labor intensive as well as expensive from the standpoint of product usage.

Systems have been provided heretofore for refilling ink jet cartridges in order to prolong the life thereof. These systems have included the manual refilling of cartridges, the refilling of cartridges through the use of systems of valves and pumps, as shown for example in Patent 4,680,696 to Ebinuma, et al., and continuous ink refill systems such as shown, for example, in patents 4,831,389 to Chan, 5,159,348 to Dietl, et al., and 5,469,201 to Erickson, et al. In a system such as that to which the present invention is directed, ink is continuously supplied to a cartridge from a remotely located ink reservoir through flexible tubing and wherein the reservoir is located in the printer below the cartridge and ink is drawn into the cartridge from the reservoir by a slight vacuum that is created as the ink within the cartridge is depleted. The reservoir is positioned below the cartridge to prevent flooding which can occur if the bag is positioned above the cartridge such that the head pressure of the ink in the supply line causes ink to be forced out of the cartridge nozzles and onto the surface of the nozzle plate. Such excess ink can adversely effect or even block the firing of the cartridge jet. At the same time, if the remote ink supply is positioned too far below the cartridge, the vacuum within the cartridge will not be sufficient to pull the ink into the cartridge from the reservoir. Accordingly, there is a fairly narrow operating window for the position of the reservoir relative to the cartridge. Since all of the ink in the reservoir must fall within the operating window, the size of the reservoir can be severely limited. Other concerns exist with respect to maximizing the utilization of space for the reservoir and maximizing the quantity of the volume of ink therein which is delivered or withdrawn from the reservoir. Moreover, in the systems heretofore provided, the connection of the supply tubing to the cartridge does not optimize protection of the latter from becoming disconnected from the cartridge during handling and/or is not routed relative to the cartridge so as to preclude interference with manipulation of the cartridge during insertion and removal thereof from a printer.

### SUMMARY OF THE INVENTION

According to the present invention, an ink delivery system for the continuous refilling of an ink jet cartridge is provided which advantageously minimizes and/or overcomes the foregoing and other disadvantages encountered in connection with the use of such systems heretofore available. More particularly in this respect, a delivery system according to the present invention includes an ink reservoir in the form of a bag of flexible plastic sheet material having a structure which provides for containing a desired volume of ink for a given application and for optimizing depletion of the volume of ink from the bag during use such that a minimum amount of ink is left in the bag. Moreover, the structure provides a thin profile for the bag and thus a small head height variation over the life of the bag from the full to the empty condition thereof. In particular in this respect, the bag, when filled with ink, has length, width and height dimensions which provide an Aspect Ratio which, preferably, is in excess of four. The Aspect Ratio is the smaller of the length and width dimensions divided by the height. Accordingly, for example, if the bag has a length of 8 inches, a width of 3⅜ inches, and a height when filled of 3/4 inch the Aspect Ratio for the bag is 4.5. The low profile provided by an Aspect Ratio greater than four maximizes the quantity of ink delivered from the bag and, thus, minimizes ink loss through non-use. With respect to depleting the ink from the bag during use, the flexible sides of the bag collapse together as the bag is emptied and, as they collapse together, a thin channel is formed which permits the ink to flow by capillary action from all areas of the bag to the exit port thereof. The capillary action increases as the ink is depleted and the channel narrows.

In accordance with a further aspect of the invention, the bag has separate fill and exit ports, and the exit port is connected by flexible tubing to an ink cartridge to provide a closed supply system which does not require any venting in the system, such as by a vent hole somewhere in the system, and the totally closed system eliminates any chance of spillage during handling by a user. The separate fill and exit ports advantageously facilitates filling the bag in a manner which minimizes air bubbles in the ink delivery system.

In accordance with another aspect of the invention, the flexible supply tubing is coupled with the ink cartridge so as to minimize any interference with respect to manipulating the cartridge into and from its location in a printer and to minimize the application of any strain on the tubing which would potentially affect the fluid flow connection thereof with the cartridge. Preferably, with respect to these attributes, the cartridge has an inlet coupling having a leg parallel to the top wall of the cartridge, and the tubing extends upwardly along an end or side wall of the cartridge and through a tube clamping device mounted on the cartridge or an opening through the cartridge handle for connection with the leg of the inlet coupling. Accordingly, the tubing is closely adjacent to the top and walls of the cartridge and is associated therewith so as to allow full use of the cartridge handle for installing and removing the cartridge relative to a printer while being relieved of strain at the point of connection with the cartridge.

### BRIEF DESCRIPTION OF THE DRAWINGS

The foregoing advantages of the present invention, and others, will in part be obvious and in part pointed out more fully hereinafter in conjunction with the written description of preferred embodiments illustrated in the accompanying drawings in which:

FIG. 1 is a perspective view of the component parts of an ink delivery system in accordance with the invention;

FIG. 2 is a cross-sectional elevation view through the reservoir bag taken along line 2-2 in FIG. 1;

FIG. 3 is an enlarged sectional elevation view through the fill port of the bag taken along line 3-3 in FIG. 2;

FIG. 4 is an enlarged sectional elevation view through the exit port of the bag taken along line 4-4 in FIG. 2; and,

FIG. 5 is a perspective view of the component parts, except for the reservoir bag, of another embodiment of an ink delivery system according to the invention.

### DESCRIPTION OF PREFERRED EMBODIMENTS

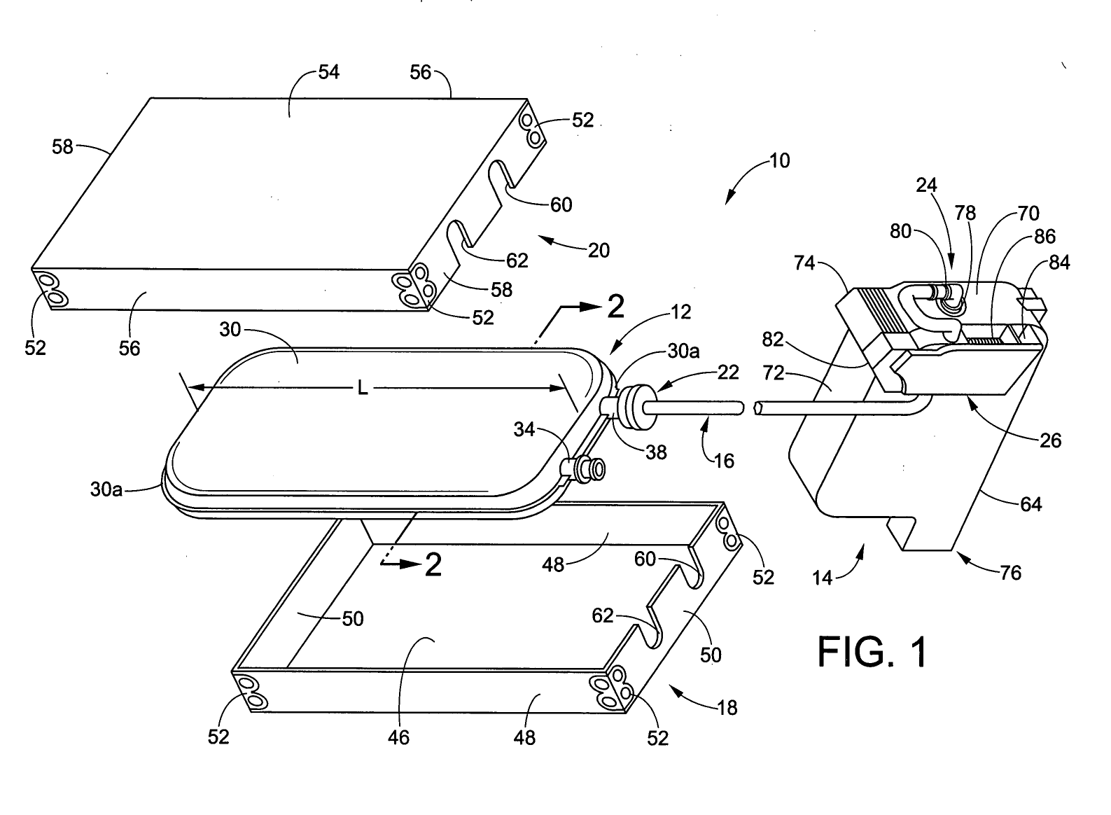

Referring now in greater detail to the drawings, wherein the showings are for the purpose of illustrating preferred embodiments of the invention only and not for the purpose of limiting the invention, an ink delivery system 10 in accordance with the present invention includes, primarily, an ink reservoir bag 12, an ink cartridge 14 and a flexible ink supply tube 16 connecting the cartridge with the reservoir bag as set forth hereinafter. Preferably, as is also set forth in greater detail hereinafter, the system further includes an enclosure for the reservoir bag which, in the embodiment of FIG. 1, comprises tray-like bottom and cover components 18 and 20, respectively. Still further, a check valve 22 is preferably provided in supply tubing 16 for precluding the back flow of ink into the reservoir bag, an ell fitting 24 is provided for routing the supply tubing parallel to the top wall of the cartridge, and strain relieving and clamping arrangements are provided which, respectively, relieve the strain on the supply tubing at the fitting and provide for selectively opening and closing the supply tubing to the flow of ink from the reservoir bag to the ink cartridge. In the embodiment of FIG. 1, both of the strain relief and clamping functions are provided by a clamping device 26 mounted on the cartridge.

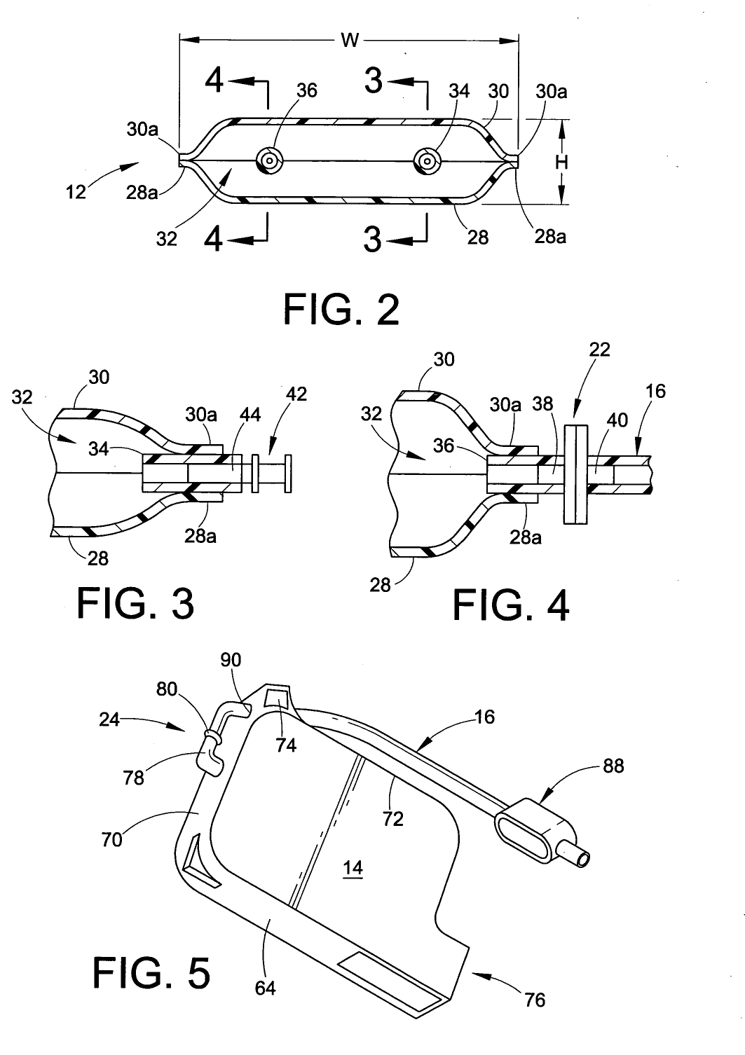

As shown in FIGS. 1-4, bag 12 is defined by a pair of sheets flexible plastic material 28 and 30 having corresponding peripheral edges 28a and 30a which overlie one another and are bonded together, such as by heat sealing, to provide an ink chamber 32 therebetween. Preferably, sheets 28 and 30 are polyvinylchloride sheets having a thickness of 0.015 inch. When filled with ink as depicted in FIGS. 1-4, the bag has a length L, a width W, and a height H and, in accordance with one aspect of the invention, these dimensions provide an Aspect Ratio which preferably is greater than 4. The Aspect Ratio, as mentioned hereinabove, is the lesser of the length and width dimensions divided by the height dimension.

In accordance with one aspect of the invention, ink reservoir bag 12 has separate inlet and exit ports respectively defined by inlet and exit tubes 34 and 36 which extend between and are bonded to sheets 28 and 30 along the perimeter of the bag as defined by peripheral edges 28a and 30a of the sheets. Preferably the fill and exit ports extend through the periphery of the bag along one of the narrower dimensions as defined by width W and the tubes are bonded to the sheets such as by a heat seal or through the use of a suitable adhesive. The tubes have inner ends which open into chamber 32 and outer ends which extend a short distance beyond the outermost edges of peripheral edges 28a and 30a of the sheets. In a preferred embodiment, exit port tube 36 has an inner diameter of 0.17 inch, an outer diameter of 0.25 inch, and a length of 0.75 inch, and fill port tube 34 has an inner diameter of 0.24 inch, an outer diameter of 0.30 inch, and a length of 0.75 inch. Check valve 22 is interposed between tube 36 and tubing 16 and, in this respect, includes an inlet stem 38 received in the outer end of tube 36 and an outlet stem 40 received in supply tubing 16. Fill port tube 34 provides an injection sight for a lure lock component 42 having a stem 44 received in the outer end of tube 34. Preferably, supply tubing 16 has an inner diameter of 0.12 inch and is silicone tubing having a durometer hardness of 50. It will be appreciated, however, that PVC or vinyl tubing having durometer values in the range of 65-70 can be used as well as other tubing.

In accordance with another aspect of the invention, and as mentioned above, a container comprising bottom and cover components 18 and 20, respectively, is provided for enclosing reservoir bag 12 to provide protection for the latter, including protection against the application of pressure on the bag during shipping, system installation and cleaning procedures. Moreover, the container facilitates stacking of the containers in a printer and adds aesthetically to the supply system. In the embodiment illustrated, bottom 18 is constructed from a sheet of suitable cardboard which is cut and folded to provide a bottom wall 46, opposite side walls 48 and opposite end walls 50, and the side walls and end walls are interconnected at the junctures therebetween by metal corner staples 52. Similarly, cover 20 is constructed from cardboard material which is cut and folded to provide a top wall 54 opposite side walls 56 and opposite end walls 58. Again, the side walls and end walls are interconnected at the junctures therebetween by metal corner staples 52, and it will be appreciated that top wall 54, side walls 56, and end walls 58 are dimensioned in length and width for cover 20 to receive bottom 18 therein with the side walls and end walls thereof within and facially engaging the corresponding one of the side walls and end walls of the cover. Preferably, the side walls and end walls of bottom 18 and cover 20 are of a height which provides for the bottom edges of the side walls and end walls of the cover to be generally coplanar with the outer side of bottom wall 46 of the bottom of the container. End walls 50 and 58 at one end of each of the bottom and cover components are each provided with a pair of spaced apart U-shaped slots 60 and 62 opening into the corresponding end wall from the free edge thereof. When the bottom and cover components are assembled with bag 12 therebetween, each of the pairs of slots 60 and 62 cooperatively provide a generally circular opening through which exit port 38 and fill port 34 extend, respectively, such that the check valve and lure lock components are outside the container. It will be appreciated, of course, that other container structures can be used. In this respect, for example, the bottom and top components can be constructed from plastic material, and with such a construction the top could be a flat sheet of plastic overlying and suitably supported on and/or interengaged with the bottom.

Ink cartridge 14 has a front wall 64, a top wall 70, and a rear wall 72 and, in a well-known manner, the cartridge is provided with a handle 74 at the juncture between top wall 70 and rear wall 72. As is further well known, the cartridge includes a printhead 76. Handle 74 facilitates introducing and removing the cartridge relative to a cartridge holder in a printer. As mentioned above, cartridge 14 includes an ell fitting 24 for connecting tubing 16 with the cartridge and a clamping device 26 which, in this embodiment, is operable to open and close tubing 16 to the flow of ink to and from the cartridge and, additionally, provides strain relief for the connection of tubing 16 to fitting 24. More particularly with regard to these features, fitting 24 includes first and second legs 78 and 80, respectively, and leg 78 extends downwardly through top wall 70 and is suitably interengaged with the cartridge for the inner end of the leg to open into the ink chamber of the cartridge. Second leg 80 is closely adjacent to top wall 70 and extends parallel thereto and toward handle 74 of the cartridge. The corresponding end of tubing 16 is attached to leg 80, and the disposition of leg 80 relative to top wall 70 of the cartridge advantageously enables maintaining a low profile for the cartridge and tubing as well as optimizing protection of the tubing. Clamping device 26 includes first and second clamping members 82 and 84, respectively, and member 82 is suitably mounted on the cartridge against displacement relative thereto. Clamping member 84 is mounted on member 82 for sliding interengagement therewith, and a spring 86 is interposed between the two members and biases member 84 to the position thereof shown in FIG. 1 relative to member 82. Tubing 16 extends downwardly between the clamping members and, in the position of the component parts shown in FIG. 1, the clamping members interengage the tubing therebetween so as to close the latter to the flow of ink therethrough. When the clamping members are in the position shown in FIG. 1, the cartridge is out of the printer and, when the printer is introduced into a cartridge holder in the printer, clamping member 84 engages against a wall of the holder and is displaced rearwardly relative to member 82 whereby, when the cartridge is fully in the printer, the clamping members are disengaged from the tubing so as to allow the flow of ink therethrough. Regardless of whether the clamping members are in the clamping or unclamping positions thereof, the passage of tubing 16 therebetween and thence to leg 80 of fitting 24 relieves strain on the tubing at the point of connection thereof with fitting 24.

FIG. 5 illustrates an alternative to the clamping and strain relief arrangement shown in FIG. 1. In this respect, clamping is achieved through the use of a manually operable pinch clamp 88 mounted on tubing 16 and, preferably, within three to four inches of the connection of tubing 16 with fitting 24. Strain relief for the tubing is provided by extending the tubing upwardly through an opening 90 through handle 74 and generally centrally between the opposite sides thereof and thence parallel across top wall 70 of the cartridge to leg 80 of fitting 24. As will be appreciated from FIGS. 1 and 5, both arrangements advantageously allow full use of the cartridge handle for installation and removal of the cartridge relative to a printer. It will be appreciated in connection with FIG. 5 that the pinch clamp is in a closed position during shipping, system installation or cleaning procedures when the cartridge is outside a printer, and that the clamp is open during normal printer operations. It will be appreciated that other strain relief arrangements of this character can be devised. In this respect, for example, the tubing can enter an opening in the top of the cartridge handle and exit through an opening in the side of the handle, depending on the routing desired for the tubing.

While considerable emphasis has been placed herein on the structures of and structural interrelationships between the component parts of the preferred embodiments of the invention, it will be appreciated that other embodiments can be devised and that many changes can be made in the preferred embodiments without departing from the principals of the invention. In particular in this respect, it is to be understood that a bag formed by folding a sheet of plastic material to provide overlying sheets bonded about the periphery thereof is intended to correspond to a bag comprising two sheets of plastic material having peripheral edges bonded together as shown and described herein. Accordingly, it is to be distinctly understood that the foregoing descriptive matter is to be interpreted merely as illustrative of the invention and not as a limitation and that it is intended to include other embodiments and all modifications of the preferred embodiments insofar as they come within the scope of the appended claims or the equivalents thereof.

Having thus described the invention, it is so claimed:

1. In an ink delivery system for an ink cartridge comprising, an ink reservoir bag of flexible plastic sheet material, an ink cartridge, and flexible tubing connecting said bag and said cartridge in flow communication with one another, the improvement comprising: said bag having separate fill and exit ports, said exit port being coupled with said tubing for delivering ink from said bag to said cartridge.

2. The improvement according to claim 1, and a check valve interposed between said exit port and said tubing to preclude the flow of ink in the direction from said cartridge to said bag.

3. The improvement according to claim 1, wherein said bag comprises two sheets of plastic material having peripheral edges bonded together to provide an ink chamber therebetween, said fill and exit ports including corresponding tubes between said peripheral edges and opening into said chamber.

4. The improvement according to claim 3, wherein said peripheral edges provide said bag with a perimeter and said fill and exit ports are adjacent one another along said perimeter.

5. The improvement according to claim 4, wherein said perimeter is rectangular and includes opposed pairs of long and short sides, said fill and exit ports being in one of the short sides.

6. The improvement according to claim 3, wherein said bag has a perimeter and first and second orthogonal dimensions with respect thereto, said first dimension being equal to or less than said second dimension, said bag having a thickness when filled with ink, and said first dimension being at least four times greater than said thickness.

7. The improvement according to claim 1, wherein said cartridge includes a handle, said tubing being connected to said cartridge adjacent said handle, and means on said cartridge interengaging with said tubing to relieve strain thereon.

8. The improvement according to claim 7, wherein said means interengaging with said tubing includes an opening through said handle receiving the tubing.

9. The improvement according to claim 8, wherein said handle includes a top side and said opening is downwardly through said top side.

10. The improvement according to claim 7, wherein said means interengaging with said tubing includes a tube clamping device.

11. The improvement according to claim 10, wherein said tube clamping device includes first and second members receiving said tubing therebetween and being displaceable relative to one another between clamping and unclamping positions relative to said tubing to respectively close and open the tubing to the flow of ink therethrough.

12. The improvement according to claim 11, and a spring biasing said members toward said clamping position.

13. The improvement according to claim 1, wherein said bag has a perimeter and first and second orthogonal dimensions with respect thereto, said first dimension being equal to or less than said second dimension, said bag having a thickness when filled with ink, and said first dimension being at least four times greater than said thickness.

14. The improvement according to claim 1, further including a container for said bag.

15. The improvement according to claim 14, wherein said container encloses said bag and includes a wall having fill and exit port openings respectively receiving said fill and exit ports.

16. The improvement according to claim 15, wherein said container includes a tray and a cover for said tray.

17. The improvement according to claim 1, and a clamp for selectively opening and closing said tubing to the flow of ink from said bag to said cartridge.

18. The improvement according to claim 17, wherein said clamp is a manually operable clamp on said tubing.

19. The improvement according to claim 17, wherein said clamp is on said cartridge and includes first and second members receiving said tubing therebetween and being displaceable relative to one another between clamping and unclamping positions relative to said tubing to respectively close and open the tubing to the flow of ink therethrough.

20. The improvement according to claim 19, and a spring biasing said members toward said clamping position.

21. The improvement according to claim 1, wherein said cartridge includes a top wall, a tubing coupling on said top wall and having a leg parallel to said top wall, and said tubing being connected to said leg of said coupling.

22. The improvement according to claim 21, and means on said cartridge interengaging with said tubing to relieve strain thereon.

23. The improvement according to claim 22, wherein said cartridge has a handle, said leg of said coupling facing said handle, said means interengaging with said tubing including an opening through said handle, and said tubing extending from said leg of said coupling through said opening.

24. The improvement according to claim 22, wherein said means interengaging with said tubing comprises a tube clamping device including first and second members receiving said tubing therebetween and being displaceable relative to one another between clamping and unclamping positions relative to said tubing to respectively close and open the tubing to the flow of ink therethrough.

25. The improvement according to claim 24, and a spring biasing said members toward said clamping position.

26. In an ink delivery system for an ink cartridge comprising, an ink reservoir bag of flexible plastic sheet material, an ink cartridge, and flexible tubing connecting said bag and said cartridge in flow communication with one another, the improvement comprising: said bag including two sheets of plastic material having peripheral edges bonded together to provide an ink chamber therebetween, separate fill and exit ports opening into said chamber and respectively including a fill tube and an exit tube between said peripheral edges, said exit port being coupled with said flexible tubing for delivering ink from said bag to said cartridge, and a check valve interposed between said exit port and said flexing tubing to preclude the flow of ink in the direction from said cartridge toward said bag.

27. The improvement according to claim 26, further including a container for said bag, said container enclosing said bag and having a wall including fill and exit port openings respectively receiving said fill and exit ports.

28. The improvement according to claim 27, wherein said container includes a tray and a cover for said tray.

29. The improvement according to claim 26, wherein said bag has a perimeter and first and second orthogonal dimensions with respect thereto, said first dimension being equal to or less than said second dimension, said bag having a thickness when filled with ink, and said first dimension being at least four times greater than said thickness.

30. The improvement according to claim 26, wherein said cartridge includes a top wall, a tubing coupling on said top wall and having a leg parallel to said top wall, said tubing being connected to said leg of said coupling.

31. The improvement according to claim 30, and means on said cartridge interengaging with said tubing to relieve strain thereon.

32. The improvement according to claim 31, wherein said cartridge has a handle, said leg of said coupling facing said handle, said means interengaging with said tubing including an opening through said handle, and said tubing extending from said leg of said coupling through said opening.

33. The improvement according to claim 31, wherein said means interengaging with said tubing comprises a tube clamping device including first and second members receiving said tubing therebetween and being displaceable relative to one another between clamping and unclamping positions relative to said tubing to respectively close and open the tubing to the flow of ink therethrough, and a spring biasing said members toward said clamping position.

34. The improvement according to claim 26, and a clamp for selectively opening and closing said tubing to the flow of ink from said bag to said cartridge.

35. The improvement according to claim 34, wherein said clamp is a manually operable clamp on said tubing.

36. The improvement according to claim 34, wherein said clamp is on said cartridge and includes first and second members receiving said tubing therebetween and being displaceable relative to one another between clamping and unclamping positions relative to said tubing to respectively close and open the tubing to the flow of ink therethrough and a spring biasing said members toward the clamping position.

37. An ink delivery system for an ink cartridge comprising, an ink reservoir bag of flexible plastic sheet material, an ink cartridge, and flexible tubing connecting said bag and said cartridge in flow communication with one another, said bag including two sheets of plastic material having peripheral edges bonded together to provide an ink chamber therebetween, separate fill and exit ports opening into said chamber and respectively including a fill tube and an exit tube between said peripheral edges, said exit port being coupled with said flexible tubing for delivering ink from said bag to said cartridge, a check valve interposed between said exit port and said flexible tubing to preclude the flow of ink in the direction from said cartridge toward said bag, said bag having a perimeter and first and second orthogonal dimensions with respect thereto, said first dimension being equal to or less than said second dimension, said bag having a thickness when filled with ink and said first dimension being at least four times greater than said thickness, and a container for said bag having a wall including fill and exit port openings respectively receiving said fill and exit ports.

38. An ink delivery system according to claim 37, further including means on said cartridge interengaging with said flexible tubing to relieve strain thereon.

39. An ink delivery system according to claim 37, and a clamp for selectively opening and closing said tubing to the flow of ink from said bag to said cartridge.

40. An ink delivery system according to claim 37, wherein said cartridge includes a top wall, a tubing coupling on said top wall and having a leg parallel to said top wall, said tubing being connected to said leg of said coupling.

41. An ink delivery system according to claim 40, and means on said cartridge interengaging with said tubing to relieve strain thereon.

42. An ink delivery system according to claim 41, wherein said cartridge has a handle, said leg of said coupling facing said handle, said means interengaging with said tubing including an opening through said handle, and said tubing extending from said leg of said coupling through said opening.

43. An ink delivery system according to claim 41, wherein said means interengaging with said tubing comprises a tube clamping device including first and second members receiving said tubing therebetween and being displaceable relative to one another between clamping and unclamping positions relative to said tubing to respectively close and open the tubing to the flow of ink therethrough, and a spring biasing said members toward said clamping position.

44. An ink delivery system according to claim 40, and a clamp for selectively opening and closing said tubing to the flow of ink from said bag to said cartridge.

45. An ink delivery system according to claim 44, wherein said clamp is a manually operable clamp on said tubing.

46. An ink delivery system according to claim 44 wherein said clamp is on said cartridge and includes first and second members receiving said tubing therebetween and being displaceable relative to one another between clamping and unclamping positions relative to said tubing to respectively close and open the tubing to the flow of ink therethrough and a spring biasing said members toward the clamping position.

47. An ink delivery system according to claim 46, wherein said clamp interengages with said flexible tubing to relieve strain thereon.

48. An ink delivery system for an ink cartridge comprising, an ink reservoir bag of flexible plastic sheet material, an ink cartridge, and flexible tubing connecting said bag and said cartridge in flow communication with one another, said bag including two sheets of plastic material having peripheral edges bonded together to provide an ink chamber therebetween, an exit port opening into said chamber, said exit port being coupled with said flexible tubing for delivering ink from said bag to said cartridge, means on said cartridge interengaging with said flexible tubing to relieve strain thereon, a check valve interposed between said exit port and said flexible tubing to preclude the flow of ink in the direction from said cartridge toward said bag, and a container for said bag having a wall including an opening for said exit port.

49. An ink delivery system according to claim 48, wherein said means on said cartridge includes a clamp for selectively opening and closing said tubing to the flow of ink from said bag to said cartridge.

50. An ink delivery system according to claim 48, wherein said cartridge includes a top wall, a tubing coupling on said top wall having a leg parallel to said top wall, said tubing being connected to said leg of said coupling.

51. An ink delivery system according to claim 48, wherein said cartridge has a handle, said means on said cartridge interengaging with said tubing including an opening through said handle, and said tubing extending from said cartridge through said opening.

52. An ink delivery system according to claim 51, and a manually operable clamp on said tubing for selectively opening and closing said tubing to the flow of ink from said bag to said cartridge.

53. An ink delivery system according to claim 48, wherein said means interengaging with said tubing comprises a tube clamping device including first and second members receiving said tubing therebetween and being displaceable relative to one another between clamping and unclamping positions relative to said tubing to respectively close and open the tubing to the flow of ink therethrough, and a spring biasing said members toward said clamping position.

54. An ink delivery system according to claim 48, wherein said bag further includes a fill port separate from said exit port.

55. An ink delivery system according to claim 54, wherein said fill and exit ports respectively include a fill tube and an exit tube between said peripheral edges.

56. An ink delivery system according to claim 48, wherein said bag has a perimeter and first and second orthogonal dimensions with respect thereto, said first dimension being equal to or less than said second dimension, said bag having a thickness when filled with ink, and said first dimension being at least four times greater than said thickness.
